(19) United States
(12) Patent Application Publication
(10) Pub. No.: US 2010/0043011 A1
(43) Pub. Date: Feb. 18, 2010

(54) METHOD FOR TRACKING LOCAL STORAGE OF WEB PAGES

(75) Inventors: Giuseppe Fioretti, Rome (IT); Sandro Piccinini, Rome (IT); Marco Secchi, Rome (IT); Luigi Pichetti, Rome (IT)

Correspondence Address: IBM CORPORATION (ACCSP);c/o Suiter Swantz pc llo, 14301 FNB Parkway, Suite 220, Omaha, NE, 68154, US

(73) Assignee: International Business Machines Corporation, Armonk, NY (US)

(21) Appl. No.: 12/193,127

(22) Filed: Aug. 18, 2008

(51) Int. Cl. G06F 9/54

(52) U.S. Cl. 719/311

(57) ABSTRACT

The present disclosure is directed to a method for tracking client side storage of a web page. The method may comprise providing a script in the web page for responding to a save operation; responding to the save operation initiated in a browser; sending a set of tracking information to a HTTP server providing the web page and/or a particular resource to be stored; forwarding the set of tracking information to an application server; and storing the set of tracking information.

### TECHNICAL FIELD

The present disclosure generally relates to the field of computer science, and more particularly to a method for tracking client side storage of a web page.

### BACKGROUND

Access to the Internet is a popular means for searching information, ranging from cooking recipes to personal data on social networking websites. When a web page is requested, servers providing the web page may capture and store file download events, including details of the download agent, to keep track of users who have downloaded/visited the resources published on a website. Such details may include an IP address, user preferred locales, and/or browser type. However, client side storages of web pages are not being tracked or monitored. For example, a server providing a web page may not track the users that have saved parts (e.g., text and/or images on the web page) or all of the web page to a local hard disk.

### SUMMARY

The present disclosure is directed to a method for tracking client side storage of a web page. The method may comprise providing a script in the web page for responding to a save operation; responding to the save operation initiated in a browser; sending a set of tracking information to a HTTP server providing the web page and/or a particular resource to be stored; forwarding the set of tracking information to an application server; and storing the set of tracking information.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a block diagram illustrating a computing network for tracking client side storage of a web page; and

FIG. 2 is a flow diagram illustrating a method for tracking client side storage of a web page.

### DETAILED DESCRIPTION

Reference will now be made in detail to the subject matter disclosed, which is illustrated in the accompanying drawings.

When a web page is requested, a server providing the web page may be able to track the downloading of the resources constituting the web page since loading of the web page correspond to specific HTTP and/or FTP requests (e.g., through a link contained in a web page). The resources constituting the web page may include the page HTML and/or additional images and files conveying relevant data.

The user who requested the web page may utilize a built-in functionality of a browser to perform a save operation. For example, the user may choose to permanently save the web page to a local storage device for future references. The HTTP and/or FTP server providing the web page may not be able to keep track of such a save operation since the save operation may be performed on the client side (e.g., moving files from a temporary browser cache to a directory in the local file system). Tracking of save operations may be appreciated for both statistical and marketing analyses, as well as for monitoring and security reasons. For example, from the IP addresses collected, it may be possible to obtain regional statistics of visitors of a particular web page.

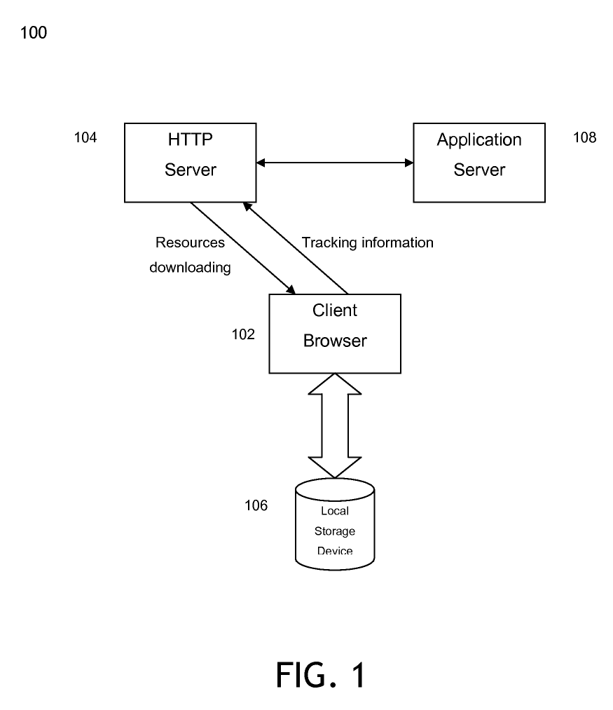

The present disclosure is directed to provide a system and method for tracking client side storage of a web page. The method may react to save operations initiated in the browser, and provide the capability to track such operations from the server side. Referring to FIG. 1, a block diagram of a computing network 100 is illustrated. The client browser 102 may download the resources constituting a web page from the HTTP server 104. When a save operation is initiated in the browser 102, the web page is stored to a local storage device 106, and the browser 102 sends a set of tracking information regarding the save operation to the HTTP server 104. The set of tracking information may comprise information obtained from the web page (e.g., page content) and/or client side information including, but not limited to, client agent data, IP Address, user preferred locales, and/or browser type information. The HTTP server 104 may forward the tracking information to an application server 108 for further processing. In one embodiment, the tracking information is stored in a database.

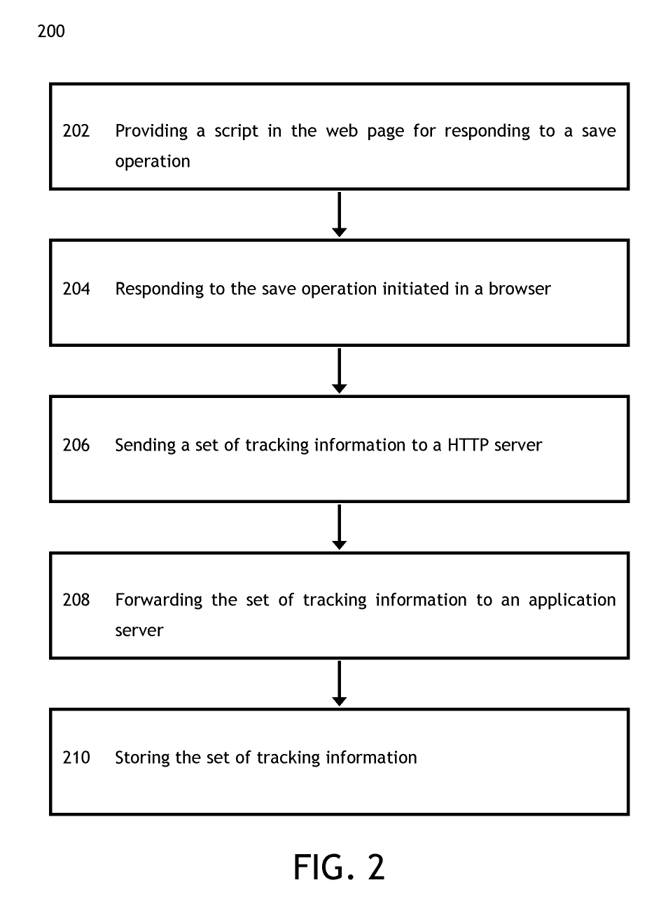

FIG. 2 shows a flow diagram illustrating steps performed by a tracking method 200 in accordance with the present disclosure. Step 202 provides a script in the web page for responding/reacting to a save operation. In one embodiment, the script is a JavaScript embedded in the web page configured to provide an Application Programming Interface (API) to capture events that happen in the browser, such as mouse clicks on page elements and/or selections on browser context menus. The API may be utilized to link custom actions to particular events. For example, the script may be configured to respond to a mouse click on a “save as” event of the browser context menu. When a user saves a web page, step 204 responds to the save operation initiated in the browser.

In step 206, a set of tracking information is sent to a HTTP server in response to the save operation. The set of tracking information may comprise information obtain from the web page (e.g., page content) and/or client side information including, but not limited to, client agent data, IP Address, user preferred locales, and/or browser type information. Depending on the purpose of tracking, the HTTP server receiving the set of tracking information may be a first HTTP server providing the web page, or alternatively, a second HTTP server providing a particular resource which is to be stored locally. It is understood that the web page and the particular resource to be stored may be provided by the same HTTP server, in which case the first and the second HTTP server are the same.

Step 208 forwards the set of tracking information received by the HTTP server to an application server. The application server may utilize a software program (e.g., a Java or a *NET program) to log or store the tracking information in step 210. It is understood that various storage means may be utilized to log or store the tracking information. In one embodiment, the tracking information is logged in to a text file. In another embodiment, a database application is utilized for storing the tracking information.

It is contemplated that AJAX (Asynchronous JavaScript and XML) technology may be utilized for implementing interactive web pages. Based on the capability of JavaScript to send asynchronous requests to the server and the implementation of callback functions for managing server responses, contents of a web page may be updated without the need for refreshing the entire page. This may allow users to keep on reading or interacting with the page while the client-server background work is being performed. Therefore, the tracking method 200 may be performed without interrupting the display of the web page.

It is understood that requests/responses communicated to/from the server may be implemented as XML objects. XML representations allow the objects to contain various types of information the JavaScript interpreter may be able to obtain from the web page and/or to retrieve from the browser. Information retrievable from the browser may include client agent data, IP Address, user preferred locales and/or browser type information.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method for tracking client side storage of a web page and discrete constituent elements of a web page, comprising:
embedding a script in the web page configured to provide an Application Programming Interface (API) for recognizing execution of a client side, browser-enabled save operation to retain a locally stored copy of the web page and discrete constituent elements of the web page, including text, images, videos, and sounds rendered thereon;
responding to the browser-enabled save operation of an Asynchronous JavaScript and XML (AJAX) technology based web page without disrupting a display of the web page to a user;
determining which constituent elements of the web page the browser-enabled save operation pertains;
generating a set of tracking information, the set of information including client agent data, IP Address, user preferred locales, and browser type information;
sending the set of tracking information to at least one of a first HTTP server providing the web page and a second HTTP server providing a particular resource to be stored;
forwarding the set of tracking information to an application server; and
storing the set of tracking information.
